(19) United States
(12) Patent Application Publication
(10) Pub. No.: US 2005/0259344 A1
(43) Pub. Date: Nov. 24, 2005

(54) High output impedance biasing for magnetoresistive elements

(76) Inventors: Motomu Hashizume, Tokyo (JP); Naoko Jinguji, Kawasaki (JP)

Correspondence Address: TEXAS INSTRUMENTS INCORPORATED, P O BOX 655474, M/S 3999, DALLAS, TX, 75265, US

(21) Appl. No.: 10/647,943

(22) Filed: Aug. 26, 2003

(51) Int. Cl. G11B 5/03

(52) U.S. Cl. 360/66

(57) ABSTRACT

Disclosed are methods and circuits (10) for biasing magnetoresistive elements (14). The methods and circuits (10) of the invention provide high output impedance current sources using an MR element (14) and a constant-voltage biasing loop (16) combined with a common-mode feedback loop (18). The common-mode feedback loop (18) is configured to maintain the potential of the MR element (14) at approximately zero Volts. Disclosed embodiments of the invention use complementary current mirrors (Q20, Q22) to substantially eliminate current differentials in the common-mode feedback loop (18) in order to hold the MR head potential at approximately zero Volts. Also disclosed are methods and circuits (10) in which a reference current source (28) is provided in a common-mode feedback subcircuit (18). Preferred embodiments of the invention are described in which bipolar transistors (Q), for example MOSFETs or JFETs, are used in circuits for performing method steps.

### TECHNICAL FIELD

The invention relates to electronic circuit biasing. More particularly, the invention relates to methods and circuits for magnetoresistive (MR) element biasing.

### BACKGROUND OF THE INVENTION

For the purposes of describing this invention, the term “magnetoresistive element” encompasses any electronic element used for detecting variations in a magnetic field by detecting a change in the resistance of the element caused by variations in the magnetic field. Also for the purposes of this disclosure, the term “MR head” is used interchangeably with “magnetoresistive element”. Examples of MR elements that are contemplated to be within the scope of this invention include, but are not limited to, dual MRs, giant MRs (GMR), tunnel junction giant MRs (TGMR), current perpendicular to plane mode (CPP) MRs and any read head which requires biasing to read out signals.

MR elements have been found to be particularly useful for reading binary data stored on magnetic media. The resistance of MR elements is dependent upon the direction and magnitude of an applied magnetic field. As the MR element is moved relative to an adjacent magnetic medium, or vice-versa, the resistance of the MR element changes. Thus, the MR element may be coupled to additional circuitry to decode the changes in resistance in order to retrieve stored data. The resistance changes in MR elements are generally nonlinear in character. It is common, therefor, to electrically bias the MR element for operation within a preferred range of its capability. In biasing, a current or voltage is applied to the MR element to set a baseline of resistance. Changes in resistance induced by the adjacent magnetic medium may then be compared against this baseline.

Various biasing schemes exist in the arts. Constant-current biasing entails coupling an MR element between two balanced current sources. One terminal of an MR head is coupled to a current source and the other terminal is coupled to a current sink. Constant-voltage biasing is applicable using current sources with a voltage feed back loop. Constant-current or constant-voltage biasing in circuits using low output impedance current sources has the advantage of making the MR head potential easy to control. Such biasing schemes suffer from attenuating the data signal output from the MR head, making the signal more susceptible to the effects of noise degradation. However, although constant-current or constant-voltage biasing in circuits using high output impedance current sources reduces susceptibility to noise, it introduces problems in controlling the MR head potential. When there is a sufficient voltage difference between the MR head and the magnetic medium, arcing can occur causing loss of data or damage to the head or medium.

Due to these and other challenges in biasing MR elements, it would be useful and desirable in the arts to provide biasing methods and circuits resistant to signal loss and noise degradation while maintaining MR head voltage at a predetermined level. It would be particularly advantageous for such methods and circuits to provide capabilities for accommodating changes in biasing levels, fast recovery times, and decreased power consumption.

### SUMMARY OF THE INVENTION

In carrying out the principles of the present invention, in accordance with preferred embodiments thereof, methods and circuits are provided for biasing MR elements responsive to feedback indicating actual bias conditions.

According to one aspect of the invention, an MR element biasing circuit and method uses an MR element and a constant-voltage biasing loop as known in the arts combined with a common-mode feedback loop. The common-mode feedback loop is operatively coupled to the MR element and the constant-voltage biasing loop in such a way as to maintain the potential of the MR element at approximately zero Volts.

According to another aspect of the invention, an MR element biasing circuit and method uses a common-mode feedback loop operatively coupled to an MR head and a constant-voltage biasing loop. The circuit includes bipolar transistors interconnected in a configuration for maintaining the MR head potential at approximately zero Volts.

According to yet another aspect of the invention, a method for biasing an MR head includes the step of providing constant-voltage biasing to an MR head subcircuit. In a further step, the current is mirrored in a common-mode feedback subcircuit and any current differential is substantially eliminated, thereby limiting the potential difference at the MR head to approximately zero Volts.

According to still another aspect of the invention, methods of MR head biasing also include a step of providing a reference current in a common-mode feedback subcircuit.

Preferred embodiments of the invention are described in which bipolar transistors are used in circuits and in performing method steps. Preferred embodiments of the invention may be implemented using either MOSFETs or JFETs.

The invention provides technical advantages including but not limited to providing high output impedance leading to good noise performance, offering stable regulation of head potential, and avoiding excessive power consumption. These and other features, advantages, and benefits of the present invention will become apparent to one of ordinary skill in the art upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1 is an example of an MR element biasing circuit and method according to a preferred embodiment of the invention; and

FIG. 2 is an example of an MR element biasing circuit and method according to a preferred alternative embodiment of the invention; and

FIG. 3 is a process flow diagram illustrating an example of steps in a preferred method of the invention.

References in the detailed description correspond to like references in the figures unless otherwise noted. Like numerals refer to like parts throughout the various figures. Descriptive and directional terms used in the written description such as upper, lower, left, right, etc., refer to the drawings themselves as laid out on the paper and not to physical limitations of the invention unless specifically noted. The drawings are not to scale, and some features of embodiments shown and discussed are simplified or exaggerated for illustrating the principles, features, and advantages of the invention.

### DETAILED DESCRIPTION OF PREFERRED EMBODIMENTS

In general, the invention uses a high output impedance circuit for MR head biasing, providing low susceptibility to noise. The invention also provides the advantages of fast recovery times when the MR head undergoes a voltage change or is switched between an “on” state and an “off” state. The methods and circuits of the invention also use less power than other solutions known in the arts, and provide MR heads common-mode voltage stability.

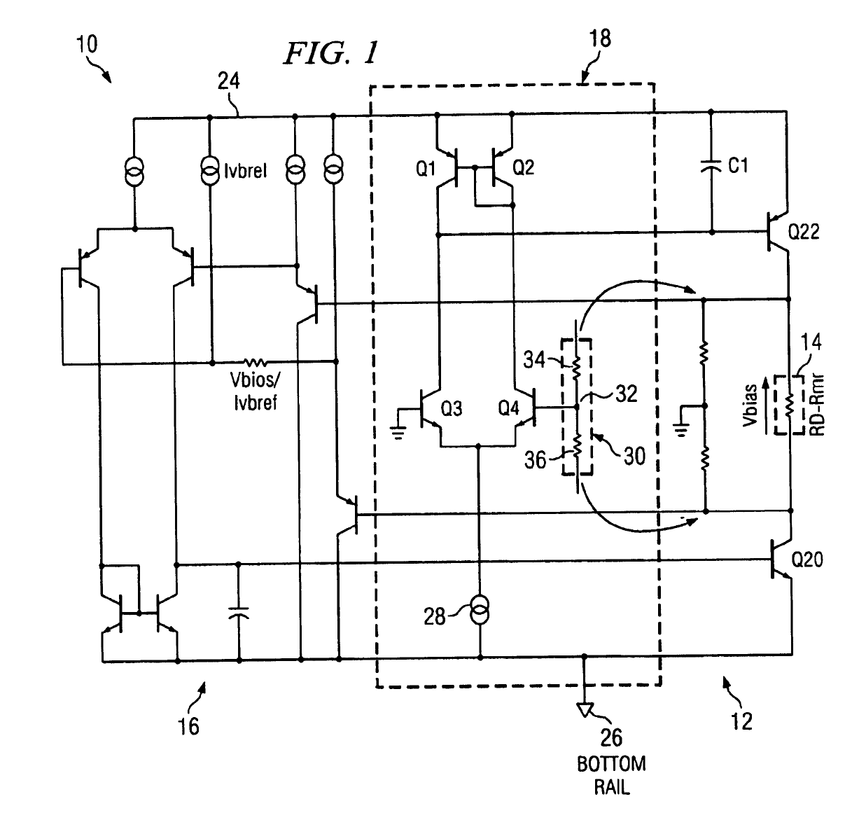

Referring first primarily to FIG. 1, an example of an MR head biasing circuit 10 is illustrated. A current source MR head circuit 12 is shown. The MR head subcircuit 12 shown is provided by way of example only and it should be understood that alternative MR head circuit arrangements 12 may be used without departure from the scope of the invention. An MR head 14 is included in the MR head subcircuit 12 and is configured for operation as is known in the arts. Multiple MR heads may be used for read/write operations. A constant-voltage biasing loop 16 is also provided as is known in the arts. Of course, the exact configuration of the constant-voltage biasing loop 16 is not essential to the practice of the invention. A common-mode feedback loop 18 joins the constant-voltage biasing subcircuit and the MR head subcircuit 12, 16. The common-mode feedback loop 18 is adapted to maintain voltage potential of the MR head 14 at approximately zero Volts relative to the common voltage of the circuit 10. The voltage feedback, or common-mode feedback loop, is realized using opposite polarity components, e.g., NPN to PNP. Thus the polarity of the transistors shown and described may be reversed without departing form the invention. Preferably, all of the transistors shown may have an emitter degeneration resistor to improve current tolerance.

Further examination of FIG. 1 will reveal that bipolar transistors Q1, Q2, Q3, Q4 are arranged as gm (voltage-current converter) amp. The current mirror of Q1 and Q2 is coupled to the top rail 24, and the differential pair of Q3 and Q4 is coupled to bottom tail 26, via a current source 28, of the circuit 10. This configuration converts voltage difference between Q3-base and Q4-base to sink or source current. Thus, a stabilizing network 30 coupled between the differential pair and the MR head, and current source Q22 driven by gm output is capable of maintaining the potential at a point, herein referred to for convenience as the central node 32, at or very near zero. Various alternative embodiments of the stabilizing network 30 may be used so long as the requirement of maintaining the central node 32 voltage at or near zero is met. As shown in FIG. 1, a preferred embodiment of the invention uses a pair of resistors 34, 36, coupled to the central node 32 and in parallel with the MR head 14.

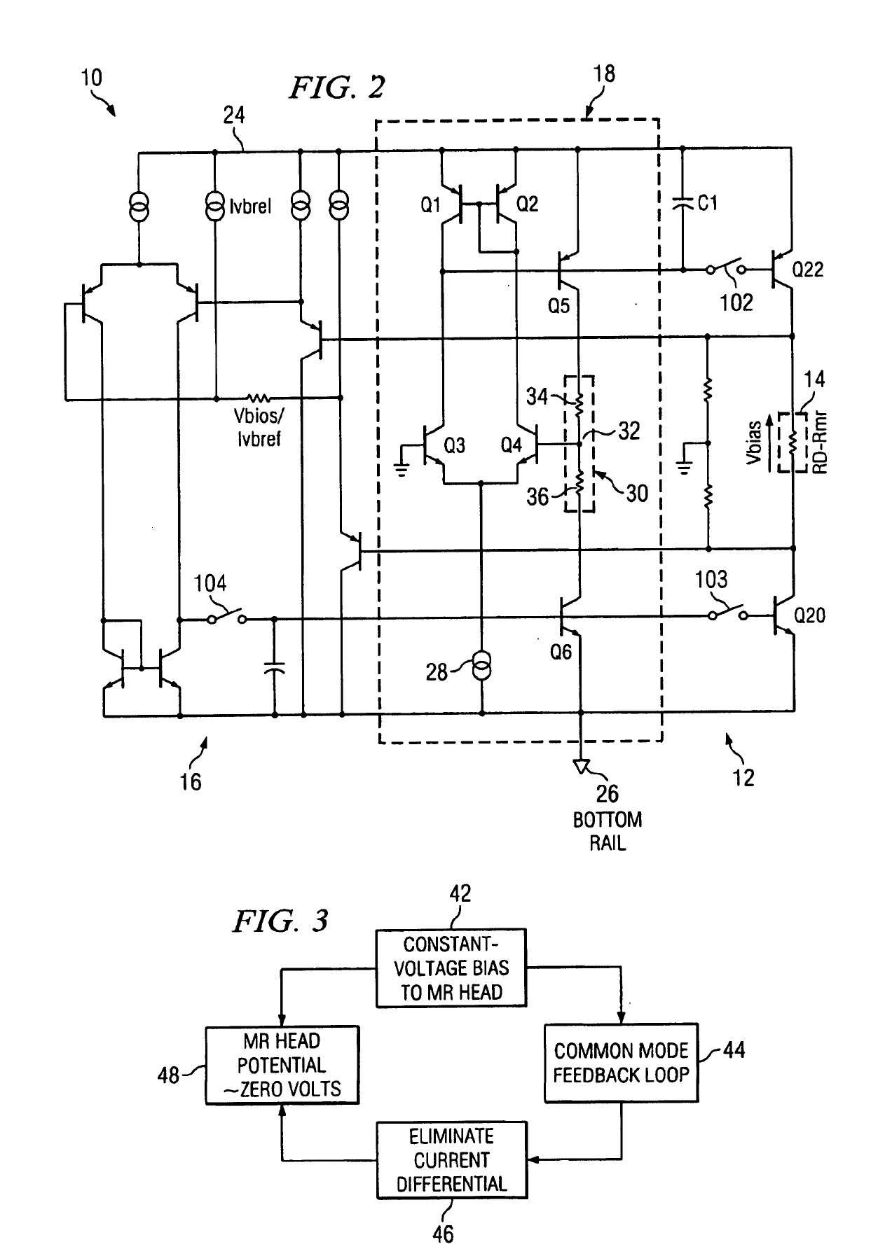

Now referring primarily to FIG. 2, an alternative embodiment of a circuit 10 according to the principles of the invention is shown. As shown, the stabilizing network 30 having a resistor pair, 34, 36, about the central node 32 may be supplemented by a ground resistor 38 electrically connected between the central node 32 and circuit ground 26. The top resistor 34 is preferably connected to a bipolar transistor Q5 providing a controlled connection to the top rail 24. Similarly, the bottom resistor 36 is preferably controllably coupled to the bottom rail 26 using a bipolar transistor Q6. Preferably, Q5 and Q6 are sized and the layout is chosen to represent or scale Q22 and Q20 currents. Thus, while the central node 32 maintains approximately zero volts, MR head 14 potential is also maintained at near zero volts. This alternative embodiment of the invention reduces the potential for delay in the circuit 10 response to changes from OFF to ON in the MR head 14 biasing current. Preferably, if current sink Q20 and current source Q22, are controlled by switches, 102, 103, 104 and are turned off, the current through bipolar transistors, Q5, Q6, maintains the voltage at capacitor C1 at a predetermined level; thus recovery times will be improved in applications where this embodiment is used.

An alternative view of the methods of the invention is illustrated in FIG. 3. As shown in step 42, the constant-voltage biasing loop provides a bias voltage to the MR head subcircuit. The arrangement of current mirrors in the intervening common-mode feedback loop meanwhile eliminates any current differential, shown at step 44. As indicated at step 46, this ensures that the voltage across the MR head remains at or very near zero Volts 48.

Thus, the invention provides high output impedance biasing for MR elements. FIG. 1 and FIG. 2 show constant-voltage biasing schemes, but alternatively, omission of the head-voltage feedback loop and current control for current sink 20 (FIG. 1, and Q6 in FIG. 2,) function in a constant-current biasing scheme. Or in FIG. 2, voltage feedback across R34 and R36, instead of the MR head 14 terminals, may be used as a constant-current biasing loop. The invention may be readily applied to MR element biasing in a variety of applications using MR head subcircuits known in the arts. While the invention has been described with reference to certain illustrative embodiments, the methods and devices described are not intended to be construed in a limiting sense. For example, various NPN or PNP transistor combinations may be substituted without departure from the methods and circuits of the invention. Various modifications and combinations of the illustrative embodiments as well as other advantages and embodiments of the invention will be apparent to persons skilled in the art upon reference to the description and claims.

1. An MR head biasing circuit comprising:
an MR head;
a constant-voltage and constant-current biasing loop; and
a common-mode feedback loop operatively coupled to the MR head and the constant-voltage and constant-current biasing loop for maintaining the MR head potential at approximately zero Volts.

2. The MR head biasing circuit according to claim 1 wherein the common-mode feedback loop further comprises:
a first current source operatively coupled to a first terminal of the MR head; and
a second current source operatively coupled to a second terminal of the MR head and to the first current source;
whereby the first and second current sources are arranged for minimizing current differential between the first current source and the second current source.

3. The MR head biasing circuit according to claim 2 further comprising a central node defined by an operative coupling of the current sources with the first and second terminals of the MR head for maintaining the MR head potential at approximately zero Volts.

4. The MR head biasing circuit according to claim 3 further comprising a reference current source operatively coupled between the central node and a bottom rail.

5. The MR head biasing circuit according to claim 1 wherein the common-mode feedback circuit further comprises:
a first bipolar transistor having an emitter coupled to a top rail of the circuit;
a second bipolar transistor having a base coupled to a base of the first bipolar transistor, the second bipolar transistor also having an emitter coupled to the top rail and a collector coupled to the base;
a third bipolar transistor having a base coupled to a bottom rail via a resistor and a collector coupled to a collector of the first bipolar transistor;
a common-mode feedback current source having a first terminal coupled to an emitter of the third bipolar transistor and having a second terminal coupled to the bottom rail;
a fourth bipolar transistor having an emitter coupled to the first terminal of the common-mode feedback current source and to the emitter of the third bipolar transistor, and also having a collector coupled to the collector of the second bipolar transistor;
a central node defined by the operative coupling of a base of the fourth bipolar transistor, and the first and second terminals of the MR head for maintaining constant voltage.

6. The MR head biasing circuit according to claim 5 wherein the bipolar transistors comprise JFETs.

7. The MR head biasing circuit according to claim 5 wherein the bipolar transistors comprise MOSFETs.

8. The MR head biasing circuit of claim 5 further comprising a stabilizing network coupled between the central node and the first and second MR head terminals.

9. The MR head biasing circuit of claim 8 wherein the stabilizing network further comprises:
a first resistor coupled between the central node and a first terminal of the MR head and a second resistor coupled between the central node and a second terminal of the MR head.

10. The MR head biasing circuit of claim 8 wherein the stabilizing network further comprises:
a first resistor coupled between the central node and a collector of a fifth bipolar transistor;
a second resistor coupled between the central node and a collector of a sixth bipolar transistor;
a third resistor coupled between a location between the first and second resistors and ground; wherein an emitter of the sixth bipolar transistor is coupled to a bottom rail;
a base of the sixth bipolar transistor is operatively coupled to the constant-voltage biasing loop and also to the MR head;
an emitter of the fifth bipolar transistor coupled to the top rail; and
a base of the fifth bipolar transistor operatively coupled to the collector of the first bipolar transistor and also to the MR head.

11. The MR head biasing circuit according to claim 10 wherein the bipolar transistors comprise JFETs.

12. The MR head biasing circuit according to claim 10 wherein the bipolar transistors comprise MOSFETs.

13. An MR head biasing circuit comprising:
an MR head;
a constant-voltage and constant-current biasing loop; and
a common-mode feedback loop operatively coupled to the MR head and the constant-voltage and constant-current biasing loop for maintaining the MR head potential at approximately zero Volts, the common-mode feedback loop further comprising:
a first bipolar transistor having an emitter coupled to a top rail of the circuit;
a second bipolar transistor having a base coupled to a base of the first bipolar transistor, the second bipolar transistor also having an emitter coupled to the top rail and a collector coupled to the base;
a third bipolar transistor having a base coupled to a bottom rail via a resistor and a collector coupled to a collector of the first bipolar transistor;
a common-mode feedback current source having a first terminal coupled to an emitter of the third bipolar transistor and having a second terminal coupled to the bottom rail;
a fourth bipolar transistor having an emitter coupled to the first terminal of the common-mode feedback current source and to the emitter of the third bipolar transistor, and also having a collector coupled to the collector of the second bipolar transistor;
a central node defined by the operative coupling of a base of the fourth bipolar transistor, and the first and second terminals of the MR head for maintaining constant voltage;
a first resistor coupled between the central node and a collector of a fifth bipolar transistor;
a second resistor coupled between the central node and a collector of a sixth bipolar transistor;
a third resistor coupled between a location between the first and second resistors and ground; wherein
an emitter of the sixth bipolar transistor is coupled to the bottom rail;
a base of the sixth bipolar transistor is operatively coupled to the constant-voltage biasing loop and also to the MR head;
an emitter of the fifth bipolar transistor coupled to the top rail; and
a base of the fifth bipolar transistor operatively coupled to the collector of the first bipolar transistor and also to the MR head.

14. The MR head biasing circuit according to claim 13 wherein the bipolar transistors comprise JFETs.

15. The MR head biasing circuit according to claim 13 wherein the bipolar transistors comprise MOSFETs.

16. An MR head biasing method comprising the steps of:
providing constant-voltage biasing to an MR head subcircuit;
mirroring the current in a common-mode feedback subcircuit and substantially eliminating any current differential;
thereby maintaining the potential difference at the MR head to approximately zero Volts.

17. An MR head biasing method according to claim 16 further comprising the step of providing reference current in the common-mode feedback subcircuit.
